(19) United States
(12) Patent Application Publication
(10) Pub. No.: US 2005/0197979 A1
(43) Pub. Date: Sep. 8, 2005

(54) Speculation count in a genetic algorithm

(76) Inventors: David M. Anderson, Fort Collins, CO (US); Tyson R. McGuffin, Fort Collins, CO (US); Thomas W. Chen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/762,099

(22) Filed: Jan. 21, 2004

(51) Int. Cl. G06N 3/00

(52) U.S. Cl. 706/13

(57) ABSTRACT

Systems and methods are disclosed for selecting a value set associated with a set of parameters. A genetic algorithm generates at least one generation of speculative chromosomes that represent value set variations of a plurality of value sets. Each generation of speculative chromosomes are assigned a speculative count corresponding to a speculative chromosome generation. Validation is initiated once at least one speculative chromosome has a predetermined speculative count.

### CROSS REFERENCE TO RELATED APPLICATIONS

This application is related to the following commonly assigned co-pending patent applications entitled: “SPECULATIVE POOL,” Attorney Docket No. 200309414-1; “POSTPONING VALIDATION OF SPECULATIVE CHROMOSOMES,” Attorney Docket No. 200309415-1; “SYSTEMS AND METHODS FOR SELECTING A VALUE SET,” Attorney Docket No. 200309416-1, all of which are filed contemporaneously herewith and are incorporated herein by reference.

### BACKGROUND

Genetic algorithms are application technologies inspired by mechanisms of inheritance and evolution of living things. In the evolution of living things, genomic changes like crossovers of chromosomes and mutations of genes can occur when new individuals (children) are born from old individuals (parents). In a genetic algorithm, a candidate of a solution to an optimization problem is represented as a data structure, referred to as a chromosome. The data structure represents a plurality of variables or bits referred to as genes. Typically, a plurality of n-bit parent chromosomes are generated and assigned a cost based on evaluation of a cost function. Chromosomes with lower costs are selected for generating children. Child chromosomes are generated through a process of crossover and mutation of parent chromosomes to produce new child chromosomes. Child chromosomes with lower costs replace members of the population with higher costs to assure evolutionary advance to an optimal solution.

### SUMMARY

Systems and methods for selecting a value set associated with a set of parameters are disclosed. One embodiment of the present invention relates to a system comprising a plurality of value sets represented as a plurality of real chromosomes, a genetic algorithm and a validator. The genetic algorithm generates at least one generation of speculative chromosomes that representing value set variations of the plurality of value sets. Each generation of speculative chromosomes are assigned a speculative count corresponding to a speculative chromosome generation. A validator initiates a validation once at least one speculative chromosome has a predetermined speculative count.

Another embodiment related to a method for selecting a value set associated with a set of parameters. The method comprises determining real costs for a plurality of real chromosomes that represent a plurality of value sets and generating at least one generation of speculative chromosomes that represent value set variations of the plurality of value sets. The method can also include assigning a speculative count to speculative chromosomes based on a corresponding generation of the speculative chromosome, and approximating speculative costs for the speculative chromosomes. The generating of speculative chromosome generations, assigning speculative chromosomes and approximating speculative costs is repeated, until at least one speculative chromosome has a predetermined speculative count.

In yet another embodiment, a computer readable medium having computer executable instructions is disclosed. The computer executable instructions comprise generating at least one generation of speculative chromosomes that represent value set variations of a plurality of value sets. Speculative counts are assigned to speculative chromosomes based on a corresponding generation of the speculative chromosome. The generating of speculative chromosome generations and assigning speculative counts is repeated, until at least one speculative chromosome has a predetermined speculative count.

### BRIEF DESCRIPTION OF THE DRAWINGS

FIG. 1 illustrates a block diagram of an embodiment of a system for selecting a value set associated with a set of parameters.

FIG. 2 illustrates an embodiment of an exemplary speculative pool.

FIG. 3 illustrates an embodiment of an exemplary real pool.

FIG. 4 is a graph that illustrates an embodiment of a speculative generation count as a predetermined validation criteria.

FIG. 5 illustrates a block diagram of an embodiment of a genetic algorithm system for mating parent chromosomes.

FIG. 6 illustrates a block diagram of an embodiment of a system for optimizing a circuit design.

FIG. 7 is a flow diagram that illustrates an embodiment of a methodology for selecting a value set associated with a set of parameters.

FIG. 8 is a flow diagram that illustrates another embodiment of a methodology for selecting a value set associated with a set of parameters.

FIG. 9 illustrates an embodiment of a computer system.

### DETAILED DESCRIPTION

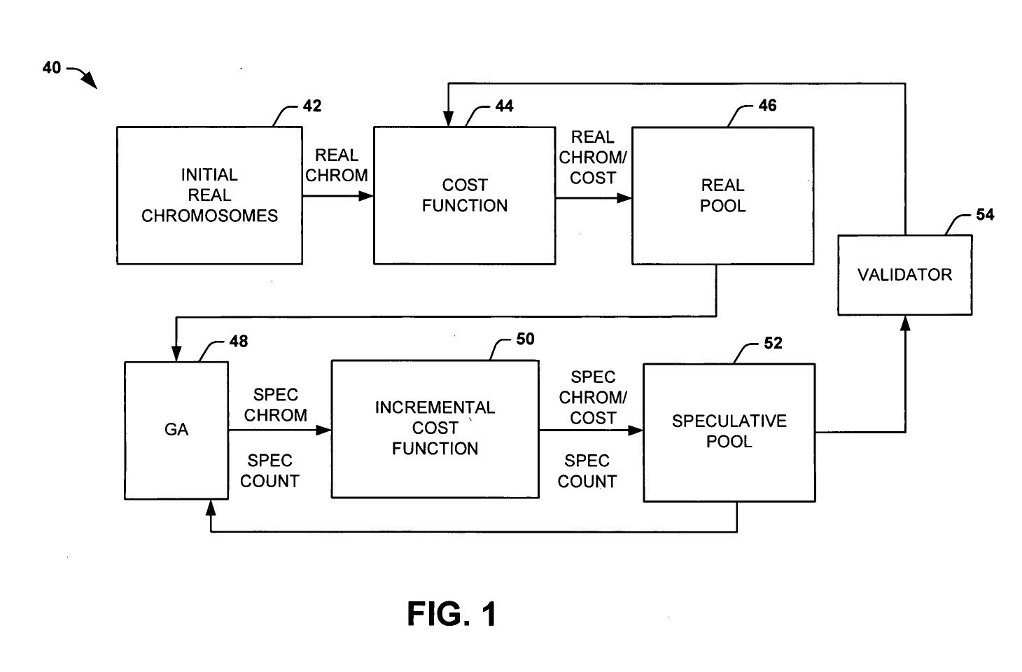

FIG. 1 illustrates a system 40 for selecting a value set associated with a set of parameters. The system 40 can be a computer, a server or some other computer readable medium that can execute computer readable instructions. For example, the components of the system 40 can be computer executable components, such as can be stored in a desired storage medium (e.g., random access memory, a hard disk drive, CD ROM, and the like), computer executable components running on a computer or design tool. The set of parameters can define properties or attributes associated with an optimizable function or structure.

An optimizable function or structure refers to a solution that can be improved with adjustment of values associated with one or more parameters to achieve a desirable acceptable solution. The optimizable function or structure can be, for example, a circuit design, a mathematical problem or some other optimizable function or structure. Each value set associated with the set of parameters represents a potential solution to the optimizable function or structure. The system 40 selects a value set based on a desired fitness value or desired minimal cost. A change in value in any one of the parameters defines a new value set. Each value set is represented by a chromosome, with each parameter representing a gene in the chromosome.

The terms “real” and “speculative” are used herein to distinguish the terms modified thereby. For example, a real cost function is a basis cost function that generates a cost (e.g., real cost) associated with a value set. A speculative cost function provides a cost (e.g., speculative cost) that is an approximate of the cost (e.g., real cost) that would be generated by the basis cost function. A speculative cost function can be arbitrary or a predetermined cost function that can be generated based on a real cost function value. The employment of a speculative cost function facilitates convergence of a desired solution by trading speed for accuracy.

A real chromosome represents a value set employed by a real cost function 44 (e.g., multi-variable cost function) to generate a real cost for a given value set. An initial set of real chromosomes 42 are provided to the real cost function 44 to generate real costs associated with each of the real chromosomes 42. The real chromosomes 42 and associated real costs are stored in a real pool 46. The real pool 46 is a data structure (e.g., a table, a list, a data base, etc.) that maintains the real chromosomes and associated real costs, or references (e.g., pointers) to the real chromosomes in memory. The real chromosomes 42 can be ranked or ordered in the real pool 46 based on minimum real costs associated with respective real chromosomes 42. The real pool 46 can include a set number of real chromosomes, such that real chromosomes having real costs exceeding a predetermined minimum cost level are discarded from the real pool 46.

The real chromosomes from the real pool 46 are employed by a genetic algorithm 48 to generate children chromosomes associated with parent chromosomes selected from the real chromosomes 42. The children chromosomes are generated through a process of crossover and mutation of parent chromosomes. The children chromosomes generated by the genetic algorithm 48 are referred to as speculative chromosomes. The children chromosomes derived from parents of the real chromosomes are a first generation of speculative chromosomes. A speculative chromosome is a value set employed by an incremental cost function 50 to generate speculative costs associated with value set variations of real chromosomes. The incremental cost function 50 provides an approximate or speculative cost for a given value set represented as a speculative chromosome. This enables an increase in speed of the system 40 since computing speculative costs, based on an approximation of the real costs, tends to be faster than computing the real costs employing the real cost function 44.

The speculative chromosomes and their associated speculative costs are stored and maintained in a speculative pool 52. The speculative pool 52 is a data structure (e.g., a table, a list, a data base, etc.) that maintains the speculative chromosomes and associated speculative costs, or references (e.g., pointers) to the speculative chromosomes in memory. The speculative chromosomes can be ranked or ordered in the speculative pool 52 based on minimum speculative costs. The speculative pool can include a set number of speculative chromosomes. Additionally, speculative chromosomes having speculative costs exceeding a predetermined minimum cost level can be discarded from the speculative pool 52. It is to be appreciated that the real pool 46 and the speculative pool 52 can include chromosome references or pointers to the value sets associated with a real or speculative chromosome stored in memory.

The genetic algorithm 48 can generate one or more generations of speculative chromosomes based on selecting parent chromosomes from the speculative pool 52. Alternatively, parents can be selected from the speculative pool 52 and the real pool 46, such that one parent is selected from the speculative pool 52 and another parent is selected from the real pool 46 for a given child chromosome. Speculative costs can be approximated for speculative chromosomes in subsequent generations, via the incremental cost function 50, similar to the approximation performed for first generation speculative chromosomes.

For example, the incremental cost function 50 can employ two parent chromosomes selected from the real pool 46, a first generation speculative child chromosome generated from the selected real chromosome parents, and the cost-evaluation of the real parents to approximate a speculative cost for a given first generation speculative child chromosome. The incremental cost function 50 approximates the cost effects of an incremental change in a value set between a parent chromosome and a child chromosome, and subtracts the cost effects from the cost determined for the parent chromosome to provide an approximate cost for the child chromosome. The speculative costs can be approximated for one or more first generation speculative children chromosomes in a similar manner.

The genetic algorithm 48 can generate a second generation of speculative children from the first generation speculative children in the speculative pool 52, which become speculative parents of the second generation. The second generation speculative parents can be selected based on minimum costs associated with the plurality of first generation speculative chromosomes residing in the speculative pool 52.

The incremental cost function 50 employs the second generation speculative parents selected from the first generation speculative chromosomes, the second generation speculative child chromosome generated from the second generation speculative parents, and the cost-evaluation of the second generation speculative parents to approximate a speculative cost for the second generation speculative child chromosome. This is repeated for each speculative children chromosomes of the second generation. The genetic algorithm 50 can then generate a third generation of speculative chromosomes from parents selected from the second generation speculative chromosomes residing in the speculative pool 52, and the incremental cost function 50 can determine speculative costs associated with the third generation speculative chromosomes. This process can be repeated for subsequent generations, until it is decided that validation of the speculative chromosomes is desired.

New speculative children of each generation and associated speculative costs are stored in the speculative pool 52. The new speculative chromosomes with lower speculative costs can replace older speculative chromosomes with higher speculative costs in the speculative pool 52. The new and older speculative chromosomes can be ranked or ordered in the speculative pool 52 based on minimal costs, so that new speculative chromosome parents and/or real parents with lower costs can be selected for the next generation. This process is repeated for subsequent generations of speculative chromosomes, until it is decided that validation of the speculative chromosomes is desired.

Each speculative chromosomes is assigned a speculative count based on the speculative generation of the speculative chromosome. For example, a first generation of speculative chromosomes are assigned a speculative count of one. A second generation of speculative chromosomes are assigned a speculative count of two. A real chromosome is assigned a speculative count of zero. If a child chromosome is generated from parent chromosomes having different speculation counts, the child chromosome is assigned a speculation count that is one higher than the parent with the highest speculative count.

A validator 54 monitors the speculative pool to determine when to initiate a validation. Validation of the speculative chromosomes is accomplished by executing the real cost function 44 on the speculative chromosomes to generate real costs associated with the speculative chromosomes. The speculative chromosomes then become real chromosomes with associated real costs. The new real chromosomes and associated real costs are added to the real pool 46. The new real chromosomes with lower real costs can replace older real chromosomes with higher real costs in the real pool 46. The new and older real chromosomes can be ranked based on minimal costs, so that real chromosomes with the minimal real costs reside in the real pool 46.

The validator 54 can initiate a validation of the entire speculative pool 52 when at least one speculative chromosome in the speculative pool has a speculative count equal to a predetermined speculative count. Alternatively, the speculative chromosomes with a predetermined speculative count or the minimum speculative cost in the speculative pool 52 can be validated.

The real pool 46 can be evaluated to determine if a desirable solution has been achieved. The desirable solution can be based on achieving a minimum cost associated with a real chromosome or when real costs converge. If the desirable solution has not been achieved, a new incremental cost function can be generated based on a new set of real chromosomes and real costs. The process of generating new generations of speculative chromosomes via the genetic algorithm 48 and speculative costs based on the new incremental cost function can be repeated. The new generations of speculative chromosomes in the speculative pool 52 can be employed to update the real chromosomes once the predetermined speculative count is satisfied. This process repeats until a desirable solution or value set based on the real cost function 44 resides in the real pool 46.

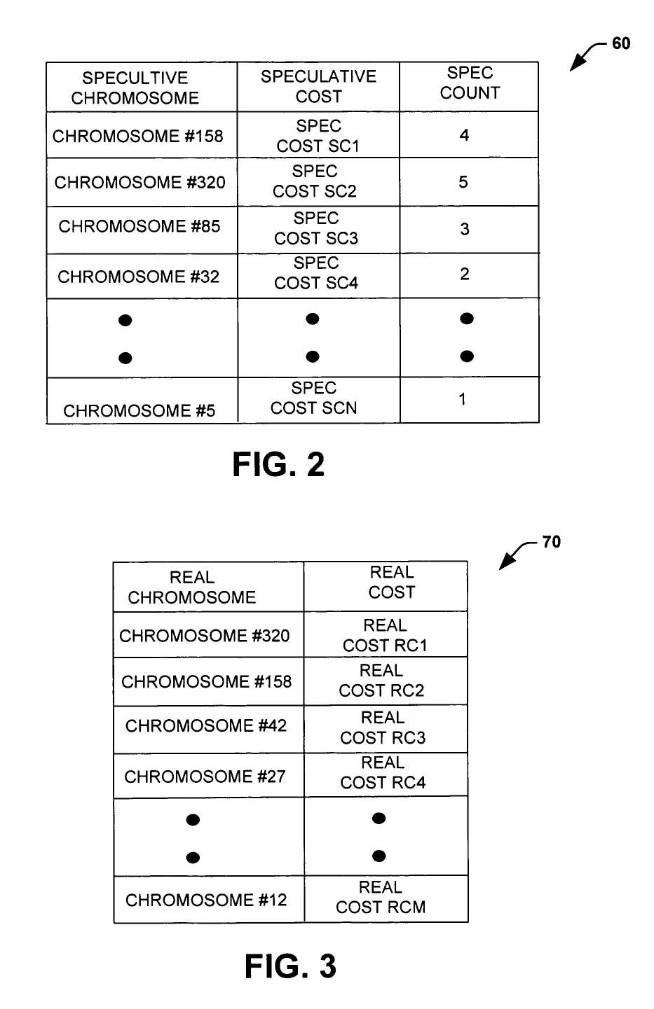

FIG. 2 illustrates an exemplary speculative pool 60. The exemplary speculative pool 60 includes a first column that identifies speculative chromosomes (e.g., by chromosome numbers), a second column that lists speculative costs associated with the corresponding speculative chromosomes, and a third column that lists speculative generation count associated with the speculative chromosomes number. The speculative chromosome number corresponds to a particular value set stored in memory that identifies a value set represented by a given chromosome. The speculative chromosome number can be a label, reference, and/or pointer to the value set associated with the speculative chromosome. The speculative generation count refers to which generation of speculation the speculative chromosome corresponds or is a member.

For example, speculative chromosomes derived from real parents are first generation speculative chromosomes. Speculative chromosomes derived from first generation speculative chromosome parents are second generation speculative chromosomes. Speculative chromosomes derived from second generation speculative chromosome parents are third generation speculative chromosomes, etc. Furthermore, speculative chromosomes derived from real and speculative parents are assigned a generation above the speculative parent.

Each generation of speculative chromosomes and associated speculative costs are compared with the current population of speculative chromosomes. Speculative chromosomes with lower costs can replace speculative chromosomes with higher speculative costs in the speculative pool 60, such that N number of speculative chromosomes are retained in the speculative pool 60, where N is an integer greater than one. The speculative chromosomes can be ranked based on minimum speculative costs (SC1-SCN), where SC1 is less than SCN. The entire speculative pool can be assigned a cost SC1, which corresponds to the speculative chromosome with the minimum speculative cost in the speculative pool 60. It is to be appreciated that the speculative chromosomes can be ranked based on other criteria in addition to speculative costs.

One or more of the speculative chromosomes can be validated by executing a real cost function on the one or more speculative chromosomes once a predetermined speculative count has been satisfied. Once a speculative chromosome is validated, the speculative chromosome can be removed from the speculative pool and added to the real pool. Alternatively, the entire speculative pool 60 can be validated removing the speculative pool from memory. A new speculative pool can be generated based on a new incremental cost function and new real chromosomes.

FIG. 3 illustrates an exemplary real pool 70. The exemplary real pool 70 includes a first column that identifies real chromosome numbers and a second column that identifies real costs associated with the corresponding real chromosome number. The real chromosome number corresponds to a particular value set stored in memory. The real chromosome number can be a label, reference, and/or pointer to the value set associated with the real chromosome. Validated speculative chromosomes are converted to new real chromosomes with associated real costs. The real costs associated with the new real chromosomes are compared with the current population of real chromosomes.

Real chromosomes with lower costs can replace real chromosomes with higher real costs in the real pool, such that M number of real chromosomes are retained in the real pool, where M is an integer greater than one. The entire real pool 70 can be assigned a cost RC1, which corresponds to the real chromosome with the minimum real cost in the real pool 70. The number of retained real chromosomes M in the real pool 70 can be equal or not equal to the number of retained chromosomes N in the speculative pool 60. The employment of separate speculative pools and real pools helps assure that speculative chromosomes and its associated speculative costs do not replace at least a substantial portion of the real costs and the real chromosomes if both were kept in similar pools. The validated speculative chromosomes in the real pool 70 have the same identifying number as the speculative chromosomes in the speculative pool 60. However, new identifying numbers can be assigned to validated speculative chromosomes added to the real pool 70.

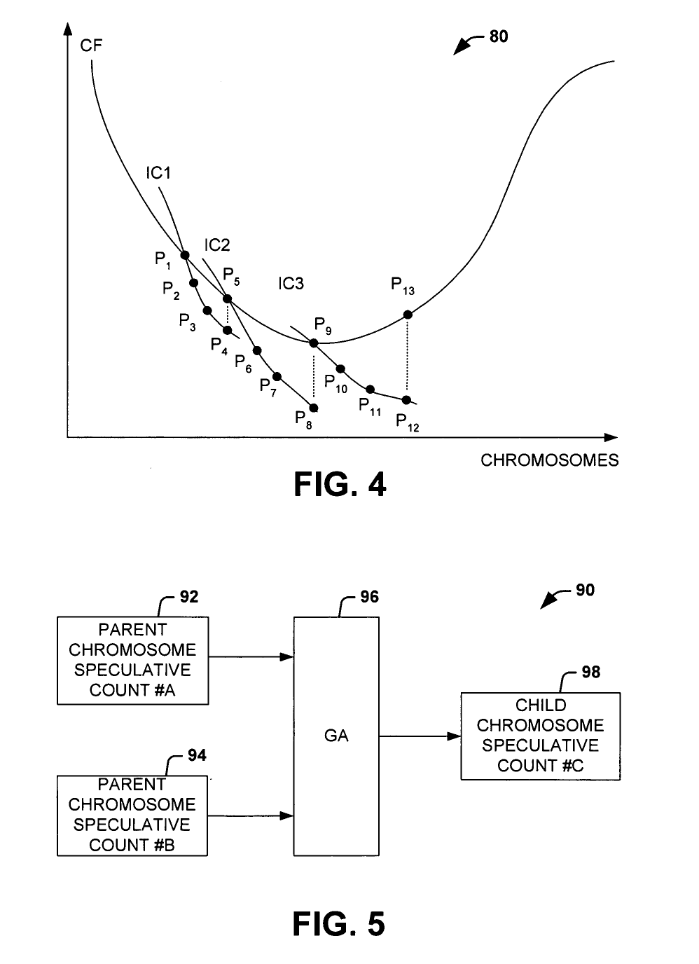

FIG. 4 is a graph 80 that illustrates a relationship between an exemplary real cost function (CF) and a plurality of incremental cost functions (IC1-IC3), which employs speculative generation count as a predetermined validation criteria. Speculative generation count refers to a degree of speculation assigned to a speculative chromosome. For example, a speculative chromosome generated by real parent chromosomes have a speculative count of one, while speculative chromosomes generated by speculative parent chromosomes with a speculative count of one have a speculative count of two. Speculative chromosomes have a speculation count that is one greater than the highest speculative count of the parent chromosomes.

The graph 80 illustrates the real cost function (CF) and the plurality of incremental cost functions (IC1-IC3) in two dimensions. However, it is to be appreciated that a multi-variable cost function will have as many dimensions as variables or parameters in the cost function. For example, a K variable cost function has K dimensions, were K is an integer greater than one. The number of variables and associated dimensions map to a single cost value. The graph 80 illustrates costs versus chromosome sets.

As illustrated in the graph 80, a real pool P1, corresponding to a pool of real chromosomes and an associated real cost resides on the cost function CF. The real pool P1 is assigned a real cost based on the minimum cost chromosome associated with the real pool P1. This allows mapping of an entire pool to a single cost. A first incremental cost function (IC 1) is generated beginning with the real pool P1 and its assigned real cost. An incremental cost function can be arbitrary or a predetermined cost function that can be generated based on a real cost function value.

A genetic algorithm employs one or more real chromosomes as parents selected from the real pool P1 to generate a first generation of speculative chromosomes. The incremental cost function IC 1 provides associated speculative costs to the set of speculative chromosomes. The first generation of speculative chromosomes and associated speculative costs are stored in a speculative pool P2. The first generation speculative chromosomes are assigned a speculative generation count of one. The speculative pool P2 is assigned a speculative cost based on the minimum cost chromosome associated with the speculative pool P2.

A genetic algorithm employs one or more speculative chromosomes as parents selected from the speculative pool P2 to generate a second generation of speculative children chromosomes. Alternatively, parents can be selected from the real pool P1 and the speculative pool P2. The incremental cost function IC1 provides associated speculative costs to the set of speculative children chromosomes. The second generation speculative chromosomes are assigned a speculative generation count of two. A new speculative pool P3 is formed that can be a combination of speculative chromosomes from the first generation and the second generation of speculative chromosomes with higher cost speculative chromosomes being discarded. The speculative pool P3 is assigned a speculative cost based on the minimum cost chromosome associated with the speculative pool P3.

A genetic algorithm employs one or more speculative chromosomes as parents selected from the speculative pool P3 to generate third generation of speculative children chromosomes. Alternatively, parents can be selected from the real pool P1 and the speculative pools P2 and P3. The incremental cost function IC 1 provides associated speculative costs to the third generation of speculative children chromosomes. The third generation speculative chromosomes are assigned a speculative generation count of three. A new speculative pool P4 is formed that can be a combination of speculative chromosomes from the first generation, the second generation and the third generation of speculative chromosomes with higher cost speculative chromosomes being discarded. The speculative pool P4 is assigned a speculative cost based on the minimum cost chromosome associated with the speculative pool P4.

A validation is initiated on the speculative chromosomes residing in the speculative pool P4, since the speculative pool includes at least one speculative chromosome with a speculative count of three. Alternatively, only the speculative chromosomes with a count of three can be validated. It is to be appreciated that the speculative count of three is employed for illustrative purposes as more or less than a speculative count of three can be employed as validation criteria to determine whether or not to validate for a given incremental cost function.

Once the validation is initiated, one or more speculative chromosomes of the speculative pool P4 are provided to the real cost function CF. A new set of real chromosomes and real costs are generated. The new set of real chromosomes and real costs are combined with the real pool P1 with lower cost chromosomes replacing higher cost chromosomes, such that a new real pool P5 is generated, and moved to the real cost function CF.

A second incremental cost function (IC2) is generated beginning with the real pool P5 and its assigned real cost. A genetic algorithm employs one or more real chromosomes as parents selected from the real pool P5 to generate first generation of speculative chromosomes. The incremental cost function IC2 provides associated speculative costs to the set of speculative chromosomes. The first generation speculative chromosomes are assigned a speculative generation count of one. The set of speculative chromosomes and associated speculative costs are stored in a speculative pool P6. The speculative pool P6 is assigned a speculative cost based on the minimum cost chromosome associated with the speculative pool P6.

The speculative pool P6 is employed to generate a new generation of speculative chromosomes and associated speculative costs. Alternatively, parents can be selected from the real pool P5 and the speculative pool P6. A genetic algorithm generates a second generation of speculative children chromosomes from the selected parents. The incremental cost function IC2 provides associated speculative costs to the second generation speculative children chromosomes. The second generation speculative chromosomes are assigned a speculative generation count of two. A new speculative pool P7 is formed that can be a combination of speculative chromosomes from the first generation and the second generation of speculative chromosomes with higher cost speculative chromosomes being discarded. The speculative pool P7 is assigned a speculative cost based on the minimum cost chromosome associated with the speculative pool P7.

The speculative pool P7 is employed to generate a third generation of speculative chromosomes and associated speculative costs. Alternatively, parents can be selected from the real pool P5 and the speculative pools P6 and P7. A genetic algorithm employs the selected parents to generate a third generation of speculative children chromosomes. The third generation speculative chromosomes are assigned a speculative generation count of three. A new speculative pool P8 is formed that can be a combination of speculative chromosomes from the first generation, the second generation and the third generation of speculative chromosomes with higher cost speculative chromosomes being discarded. The speculative pool P8 is assigned a speculative cost based on the minimum cost chromosome associated with the speculative pool P8.

A validation is initiated on the speculative chromosomes residing in the speculative pool P8, since the speculative pool P8 includes at least one speculative chromosome with a speculative count of three. It is to be appreciated that the speculative count of three is employed for illustrative purposes and more or less than a speculative count of three can be employed to determine whether or not to validate for a given incremental cost function. Additionally, a speculative count that initiates a validation can differ between cost functions.

Upon validation, one or more speculative chromosomes of the speculative pool P8 are provided to the real cost function (CF). A new set of real chromosomes and real costs are generated. The new set of real chromosomes and real costs are combined with the real pool P5 with lower cost chromosomes replacing higher cost chromosomes, such that a new real pool P9 is generated.

The set of real chromosomes in the pool P9 are employed to generate a third incremental cost function (IC3). The set of real chromosomes in real pool P9 and associated costs are employed to generate first generation of speculative chromosomes and associated speculative costs stored in a speculative pool P10.

The speculative pool P10 is employed to generate a second generation of speculative chromosomes and associated speculative costs. Alternatively, parents can be selected from the real pool P9 and the speculative pool P10. A genetic algorithm generates a set of speculative children chromosomes from the selected parents. The incremental cost function IC3 provides associated speculative costs to the set of speculative children chromosomes.

The speculative pool P10 is employed to generate a second generation of speculative chromosomes and associated speculative costs. Alternatively, parents can be selected from the real pool P9 and the speculative pool P 10. A genetic algorithm employs the selected parents to generate a second generation of speculative children chromosomes. The incremental cost function IC3 provides associated speculative costs to the new generation of speculative children chromosomes. The second generation speculative chromosomes are assigned a speculative generation count of two. A new speculative pool P11 is formed that can be a combination of speculative chromosomes from the first generation and the second generation of speculative chromosomes with higher cost speculative chromosomes being discarded. The speculative pool P 11 is assigned a speculative cost based on the minimum cost chromosome associated with the speculative pool P11.

The speculative pool P11 is employed to generate a third generation of speculative chromosomes and associated speculative costs. Alternatively, parents can be selected from the real pool P9 and the speculative pools P10 and P11. A genetic algorithm employs the selected parents to generate a third generation of speculative children chromosomes. The third generation speculative chromosomes are assigned a speculative generation count of three. A new speculative pool P12 is formed that can be a combination of speculative chromosomes from the first generation, the second generation and/or the third generation of speculative chromosomes with higher cost speculative chromosomes being discarded. The speculative pool P12 is assigned a speculative cost based on the minimum cost chromosome associated with the speculative pool P12.

A validation is initiated on the speculative chromosomes residing in the speculative pool P12, since the speculative pool P12 includes at least one speculative chromosome with a speculative count of three. Upon validation, one or more speculative chromosomes of the speculative pool P12 are provided to the real cost function (CF). A new set of real chromosomes and real costs are generated. The new set of real chromosomes and real costs are combined with the real pool P9 with lower cost chromosomes replacing higher cost chromosomes, such that a new real pool P 13 is generated.

In the example of FIG. 4, it is determined that the minimal cost assigned to the real pool P13 is higher than the minimal cost assigned to the real pool P9. Therefore, the real pool P9 offers a better solution than P113. A minimal cost real chromosome can be selected from the real chromosomes represented at P9 as a desirable solution. The selection routine then terminates. It is to be appreciated that more or less than three incremental cost functions can be generated to determine a desirable solution associated with the real cost function (CF).

FIG. 5 illustrates genetic algorithm system for mating parent chromosomes. A first parent chromosome 92 with a speculative count of A and a second parent chromosome 94 with a speculative count of B is provided to a genetic algorithm 96. A child chromosome 98 is generated through a process of crossover and mutation of parent chromosomes 92 and 94. The child chromosome 98 has a speculative count of C, where A, B and C are integers and B is greater than or equal to A. The child chromosome can have a count that is one greater than the parent chromosome with the highest speculative count (e.g., C=B+1). For example, if A corresponds to a speculative count of 2 and B has a speculative count of 3, then the child chromosome 98 will be assigned a speculative count of 4. Furthermore, if A corresponds to a speculative count of 0 (e.g., a real chromosome) and B has a speculative count of 3, then the child chromosome 98 will be assigned a speculative count of 4. It is to be appreciated that C can have other values based on the speculative count of A and/or B (e.g., C=A+B).

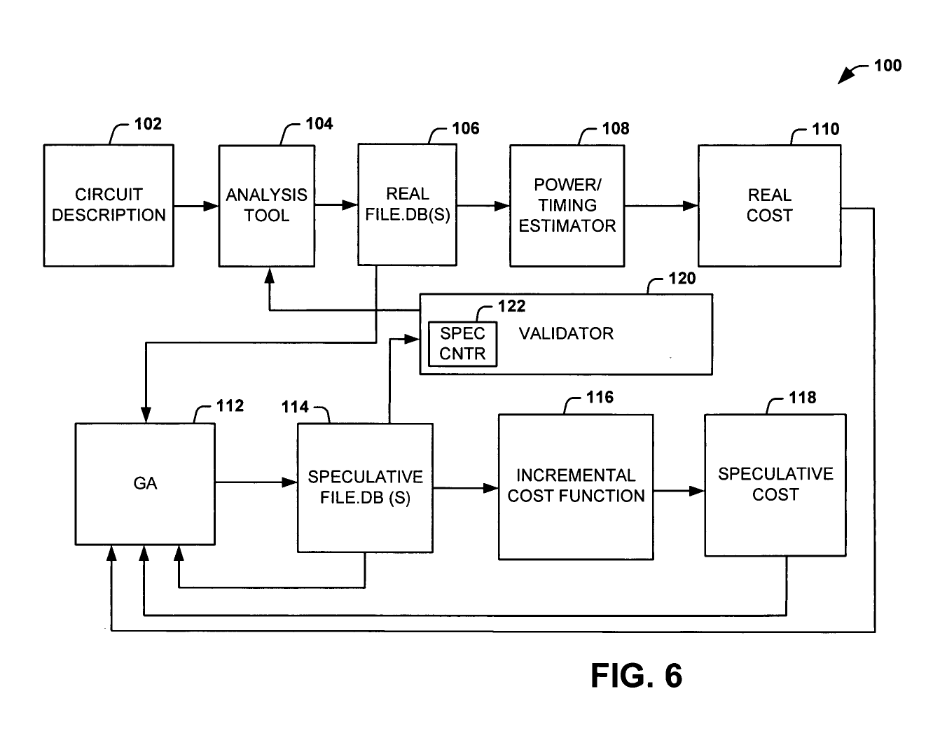

FIG. 6 illustrates a system 100 for optimizing a circuit design. The system 100 employs a circuit design description 102 to provide information to an analysis tool 104. The design description 102 can include transistor netlists, design netlists, design parasitic data and timing constraints associated with the circuit design. The analysis tool 104 executes a device modification and timing algorithm to optimize a circuit design. For example, the analysis tool 104 can be a static timing analysis tool (e.g., PATHMILL® by Synopsys) for block and chip timing verification. A static timing analysis tool will generate a plurality of circuit design configurations that correspond to device changes (e.g., transistor sizing, cell device modifications) based on timing and delay analysis to optimize the circuit design based on speed, power and area.

Alternatively, the analysis tool 104 can be a transistor autosizer (e.g., AMPS® by Synopsys). Most transistor autosizers rely on heuristic approaches that focus on finding the best combination that will meet user-defined power and speed goals without changing the functionality of the design. The transistor autosizers employ an original circuit design description to generate a plurality of circuit sizing configurations that define different optimized cell netlist configurations.

The analysis tool 104 performs timing analysis, transistor sizing optimization, device modifications and/or power analysis on the circuit design description 102. The analysis tool 104 executes timing analysis and modifies transistor sizes and/or circuit cell configurations to optimize the circuit design without disturbing the functionality associated with the circuit design. The analysis tool 104 generates one or more real file data bases 106 (File.DB(s)). Each of the one or more real file data bases 106 defines a circuit configuration, and a potential circuit design solution. Each circuit configuration or real file data base 106 is represented as a real chromosome. Any change in the circuit design parameter values (e.g., device width, device length, circuit types, cell types) defines a new real chromosome associated with the circuit design.

The information associated with the one or more real file data bases 106 is provided to a power/timing estimator 108 that generates real costs associated with each real file data base 106, as a function of power and timing characteristics. The analysis tool 104 and the power/timing estimator 108 cooperate to define a real cost function associated with optimization of the circuit design.

A genetic algorithm 112 generates a first generation of speculative chromosomes in the form of speculative file data bases 114 (File.DB(s)) through a process of crossover and mutation of parent chromosomes selected from the real file data bases 116 and associated real costs 110. The speculative file data bases 114 are provided to an incremental cost function 116, which determines speculative costs 118 associated with respective speculative file database 114.

The incremental cost function 116 employs the incremental difference between parent chromosomes having real file data bases 106 and speculative child chromosomes having speculative file data bases 114. The incremental difference and the real cost associated with the real parent file data bases 106 is employed to provide a speculative cost associated with each speculative child chromosome or speculative file data base 114. For example, a change in a circuit design parameter value, such as gate width can be made to generate a speculative file data base from one or more real file databases. An estimated change in power can be determined based on the gate width change. The estimated change in power and the power computed by the power timing/estimator 108 for the real file data base 106 can be employed to determine an approximate power associated with the speculative file data base 104.

Parent chromosomes are then selected from the speculative chromosomes 114, such that speculative chromosomes become parents of a second generation of speculative chromosomes. Alternatively, parents can be selected from the speculative chromosomes and real chromosomes, such that one parent is selected from the speculative file data base 114 and another parent is selected from the real file data base 106 for a given child chromosome. The genetic algorithm 112 produces a subsequent generation of speculative file data bases employing the selected parents and associated real or speculative costs. The speculative and/or real parent chromosomes can be selected based on minimum speculative costs. Alternatively, multiple combinations of speculative parents and/or real parents can be selected to generate various second generation children chromosomes.

The second generation speculative file data bases 114 are provided to the incremental cost function 116. The incremental cost function 116 employs the incremental difference of circuit design configuration associated with the first generation speculative file data bases and the second generation speculative file data bases. The incremental difference and the speculative cost associated with the first generation speculative chromosome parents are employed to provide a speculative cost associated with each second generation speculative child chromosomes. This process can then be repeated for subsequent generations (e.g., 3^{rd} generation, 4^{th} generation, etc.) of speculative file data bases employing parents of a previous generation.

A validator 120 monitors the generating of speculative chromosomes and updates a speculative counter 122 each time a new generation of speculative chromosomes are generated. Validation of the speculative chromosomes is accomplished by invoking the execution of the real cost function (104, 108) on the speculative file data bases 114 to generate real costs 110 associated with the speculative chromosomes. The speculative file data bases 114 then become real file data bases 106 with associated real costs. The validator 120 provides for postponing of validation until the speculative counter 122 reaches a predetermined speculation count. This allows for several generations of speculative chromosomes to be generated and associated speculative costs to be determined before it is necessary to execute the real cost function.

Once the speculation counter 122 has reach the predetermined speculative count and the incremental cost function has determined the speculative cost for the new generation of speculative chromosomes, the validator 120 invokes validation by providing the speculative file data bases 114 to the real cost function (104, 108) to generate real costs 110 associated with the speculative chromosomes. The speculative chromosomes then become real chromosomes. The new real chromosomes are evaluated to determine if a desirable solution has been satisfied. The desirable solution can be based on achieving a minimum cost associated with a real chromosome or when real costs converge. If the desirable solution has not been satisfied, a new incremental cost function can be generated based on a new set of real chromosomes and real costs. The process of generating new generations of speculative chromosomes via the genetic algorithm 112 and speculative costs based on the new incremental cost function can be repeated, until the validator 120 initiates a validation of the new speculative chromosome generations based on the same or a different speculative count. This process repeats until a desirable solution or value set based on the real cost function has been satisfied.

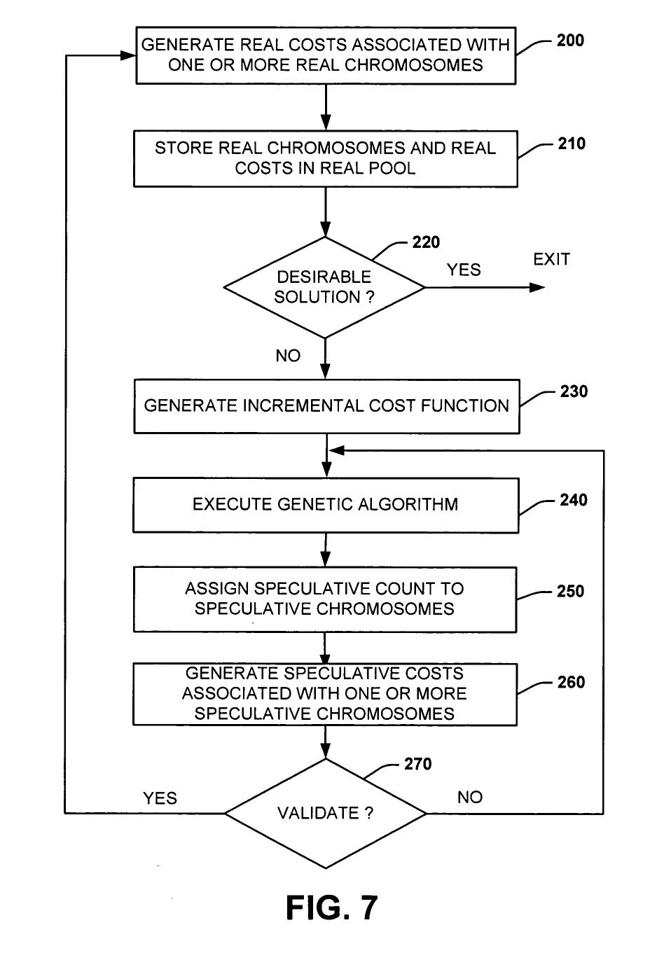

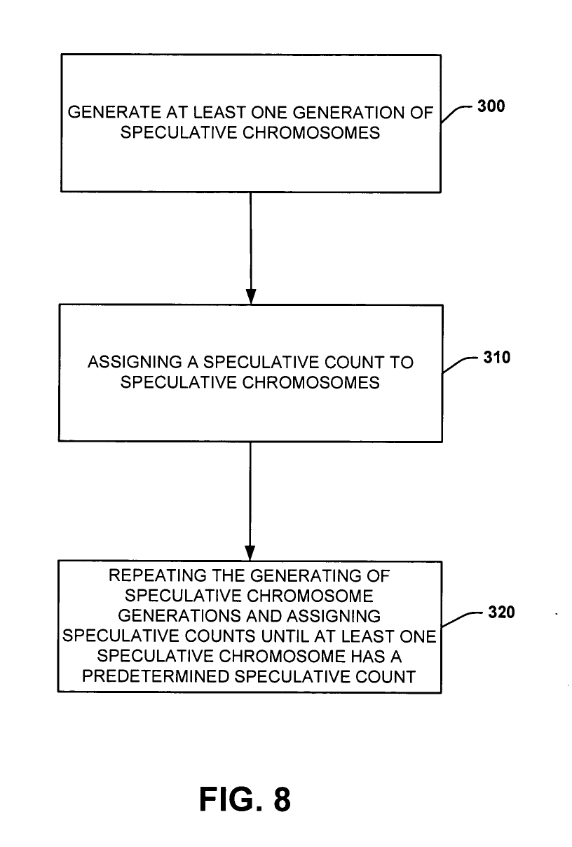

In view of the foregoing structural and functional features described above, certain methodologies that can be implemented will be better appreciated with reference to FIGS. 7-8. While, for purposes of simplicity of explanation, the methodologies of FIGS. 7-8 are shown and described as being implemented serially, it is to be understood and appreciated that the illustrated actions, in other embodiments, may occur in different orders and/or concurrently with other actions. Moreover, not all illustrated features may be required to implement a methodology.

It is to be further understood that the following methodology can be implemented in hardware, software, or any combination thereof. For example, in one embodiment the methodologies can be implemented as computer executable instructions, such as can be stored in a desired storage medium (e.g., random access memory, a hard disk drive, CD ROM, and the like). In another embodiment, a methodology can be implemented as computer executable instructions running on a computer or design tool.

FIG. 7 illustrates a methodology for optimizing a value set associated with a set of parameters. At 200, a real cost function is executed on one or more value sets associated with a set of parameters. Each value set represents a real chromosome with each parameter value representing a gene associated with the real chromosome. For example, the set of parameters can be parameters (e.g., device width, device length, circuit types, cell types) associated with a circuit design. At 210, a real cost function generates real costs for each of the one or more real chromosomes that represent one or more value sets associated with a set of parameters. The real chromosomes and real costs can be stored in a real pool. The real chromosomes and real costs can be sorted based on minimum real costs associated with a given chromosome. At 220, it is determined if a desirable solution has been obtained by analyzing the costs associated with the real chromosomes in the real pool. If a desirable solution has been satisfied (YES), the methodology terminates or exits. If a desirable solution has not been satisfied (NO), the methodology proceeds to 130.

At 230, an incremental cost function is generated based on the real chromosomes in the real pool and an associated minimum real cost assigned to the real pool. The minimum real cost assigned to the real pool can be based on the real chromosome with the lowest cost in the real pool. At 240, a genetic algorithm is executed to generate at least one speculative chromosome. A speculative chromosome is an incremental modification of a value set associated with one or more parent chromosomes. The parent chromosomes can be real or speculative. At 250, speculative counts are assigned to the speculative chromosomes based on the generation of which the speculative chromosome is a member. At 260, the incremental cost function is executed to generate speculative costs associated with one or more speculative chromosomes. The speculative chromosomes and associated speculative costs can be stored in a speculative pool.

At 270, the methodology determines whether or not to perform a validation based on whether at least one speculative chromosome has a predetermined speculative count. Alternatively, the validation can be based on whether a certain number of speculative chromosomes have the predetermined speculative count. If the methodology determines a validation is desired (YES), the methodology returns to 200. At 200, a validation is initiated such that the real cost function is executed on one or more speculative chromosomes to generate real costs associated with the one or more speculative chromosomes, thus adding the one or more speculative chromosomes to the set of real chromosomes.

If the methodology determines a validation is not desired (NO), the methodology returns to 240 to generate a new generation of speculative chromosomes and speculative costs at 250. The new generation of speculative chromosomes are assigned a speculative count number based on the generation number. The new generation of speculative chromosomes and associated speculative costs can be added to the speculative pool, such that new speculative chromosomes having lower speculative costs replace speculative chromosomes having higher speculative costs. The methodology then proceeds to 270 to determine if the validation criteria has been satisfied.

FIG. 8 illustrates an alternate methodology for selecting a value set associated with a set of parameters. At 300, the methodology generates at least one generation of speculative chromosomes that represent value set variations of a plurality of value sets. At 310, the methodology assigns a speculative count to speculative chromosomes based on a corresponding generation of the speculative chromosome. At 320, the methodology repeats the generating of speculative chromosome generations and assigning speculative counts, until at least one speculative chromosome has a predetermined speculative count.

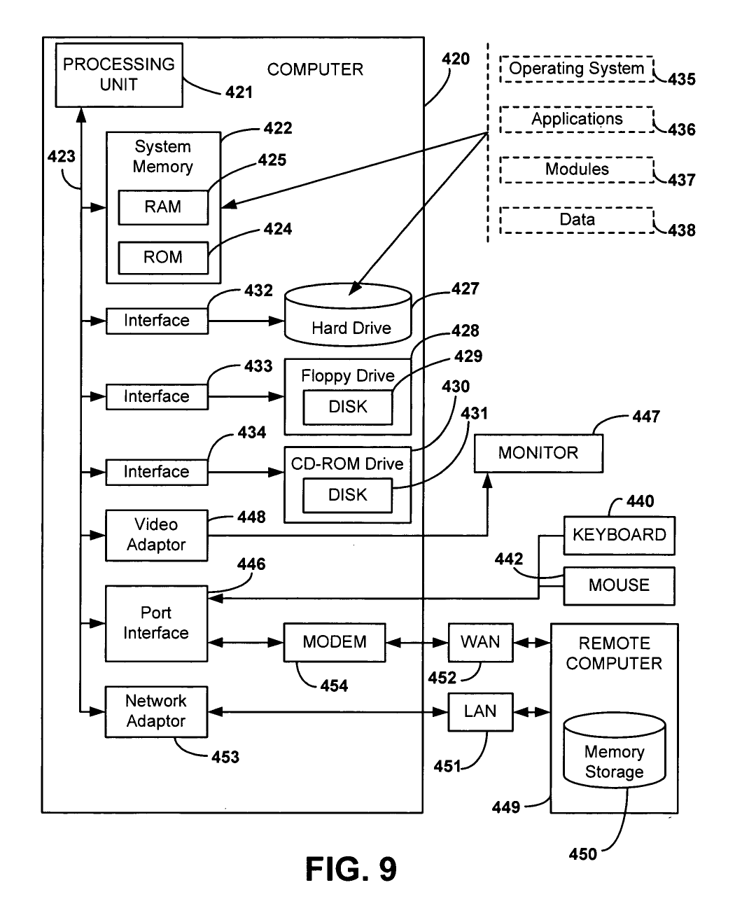

FIG. 9 illustrates a computer system 420 that can be employed to execute one or more embodiments employing computer executable instructions. The computer system 420 can be implemented on one or more general purpose networked computer systems, embedded computer systems, routers, switches, server devices, client devices, various intermediate devices/nodes and/or stand alone computer systems. Additionally, the computer system 420 can be implemented on various mobile clients such as, for example, a cell phone, personal digital assistant (PDA), laptop computer, pager, and the like.

The computer system 420 includes a processing unit 421, a system memory 422, and a system bus 423 that couples various system components including the system memory to the processing unit 421. Dual microprocessors and other multi-processor architectures also can be used as the processing unit 421. The system bus may be any of several types of bus structure including a memory bus or memory controller, a peripheral bus, and a local bus using any of a variety of bus architectures. The system memory includes read only memory (ROM) 424 and random access memory (RAM) 425. A basic input/output system (BIOS) can reside in memory containing the basic routines that help to transfer information between elements within the computer system 420.

The computer system 420 can includes a hard disk drive 427, a magnetic disk drive 428, e.g., to read from or write to a removable disk 429, and an optical disk drive 430, e.g., for reading a CD-ROM disk 431 or to read from or write to other optical media. The hard disk drive 427, magnetic disk drive 428, and optical disk drive 430 are connected to the system bus 423 by a hard disk drive interface 432, a magnetic disk drive interface 433, and an optical drive interface 434, respectively. The drives and their associated computer-readable media provide nonvolatile storage of data, data structures, and computer-executable instructions for the computer system 420. Although the description of computer-readable media above refers to a hard disk, a removable magnetic disk and a CD, other types of media which are readable by a computer, such as magnetic cassettes, flash memory cards, digital video disks and the like, may also be used in the operating environment, and further that any such media may contain computer-executable instructions.

A number of program modules may be stored in the drives and RAM 425, including an operating system 435, one or more application programs 436, other program modules 437, and program data 438. A user may enter commands and information into the computer system 420 through a keyboard 440 and a pointing device, such as a mouse 442. Other input devices (not shown) may include a microphone, a joystick, a game pad, a scanner, or the like. These and other input devices are often connected to the processing unit 421 through a corresponding port interface 446 that is coupled to the system bus, but may be connected by other interfaces, such as a parallel port, a serial port or a universal serial bus (USB). A monitor 447 or other type of display device is also connected to the system bus 423 via an interface, such as a video adapter 448.

The computer system 420 may operate in a networked environment using logical connections to one or more remote computers, such as a remote client computer 449. The remote computer 449 may be a workstation, a computer system, a router, a peer device or other common network node, and typically includes many or all of the elements described relative to the computer system 420. The logical connections can include a local area network (LAN) 451 and a wide area network (WAN) 452.

When used in a LAN networking environment, the computer system 420 can be connected to the local network 451 through a network interface or adapter 453. When used in a WAN networking environment, the computer system 420 can include a modem 454, or can be connected to a communications server on the LAN. The modem 454, which may be internal or external, is connected to the system bus 423 via the port interface 446. In a networked environment, program modules depicted relative to the computer system 420, or portions thereof, may be stored in the remote memory storage device 450.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system comprising:
a plurality of value sets represented as a plurality of real chromosomes;
a genetic algorithm that generates at least one generation of speculative chromosomes, the speculative chromosomes representing value set variations of the plurality of value sets, each generation of speculative chromosomes being assigned a speculative count corresponding to a speculative chromosome generation; and
a validator that initiates a validation once at least one speculative chromosome has a predetermined speculative count.

2. The system of claim 1, further comprising a real cost function that determines real costs for the plurality of real chromosomes, and an incremental cost function that determines speculative costs for speculative chromosomes.

3. The system of claim 2, the validation comprising executing the real cost function on the at least one speculative chromosome to provide a real cost associated with the at least one speculative chromosome.

4. The system of claim 1, the genetic algorithm generates a speculative child chromosome from at least one of a first parent chromosome and a second parent chromosome, wherein the speculative child chromosome is assigned a speculative count that is higher than the speculative count of the parent chromosome having the higher speculative count.

5. The system of claim 4, the at least one of a first parent chromosome and a second parent chromosome is selected from at least one of the plurality of real chromosomes and subsequent generations of speculative chromosomes

6. The system of claim 1, further comprising a speculation counter that increments for each new generation of speculative chromosomes generated by the genetic algorithm.

7. The system of claim 6, the validator initiates a validation on at least one speculative chromosome when the speculation counter has achieved a count value equal to the predetermined speculative count.

8. The system of claim 1, further comprising a speculative pool that stores speculative chromosomes and assigned speculative counts.

9. The system of claim 8, the validator initiates a validation once at least one speculative chromosome in the speculative pool has a predetermined speculative count.

10. The system of claim 9, the validator initiates a validation on the entire speculative pool once at least one speculative chromosome in the speculative pool has a predetermined speculative count.

11. The system of claim 1, the plurality of value sets being a plurality of circuit configurations generated by an optimization tool.

12. A method for selecting a value set associated with a set of parameters, the method comprising:
determining real costs for a plurality of real chromosomes that represent a plurality of value sets;
generating at least one generation of speculative chromosomes that represent value set variations of the plurality of value sets;
assigning a speculative count to speculative chromosomes based on a corresponding generation of the speculative chromosome;
approximating speculative costs for the speculative chromosomes; and
repeating the generating of speculative chromosome generations, assigning speculative chromosomes and approximating speculative costs, until at least one speculative chromosome has a predetermined speculative count.

13. The method of claim 12, the determining real costs further comprising executing a real cost function on the plurality of real chromosomes and the approximating speculative costs comprising executing an incremental cost function on the speculative chromosomes.

14. The method of claim 13, the execution of the real cost function comprising optimizing a circuit design, and the plurality of value sets being a plurality of circuit configurations generated by the optimization.

15. The method of claim 14, the speculative chromosomes representing speculative file databases that are circuit configuration variations of real file data bases, each real file data base defines a circuit configuration.

16. The method of claim 12, the generating at least one generation of speculative chromosomes comprising executing a genetic algorithm that employs parent chromosomes selected from at least one of real chromosomes and speculative chromosomes.

17. The method of claim 16, wherein a speculative child chromosome is generated from at least one of a first parent chromosome and a second parent chromosome, wherein the speculative child chromosome is assigned a speculative count that higher than the speculative count of a parent chromosome having a higher speculative count.

18. The method of claim 12, further comprising incrementing a speculation counter for each new generation of speculative chromosomes, a validation being initiated when the speculative counter has a predetermined speculative count.

19. The method of claim 12, further comprising executing a validation of the at least one speculative chromosome when at least one speculative chromosome has a predetermined speculative count, the validation comprising executing a real cost function on the at least one speculative chromosome to provide a real cost associated with the at least one speculative chromosome.

20. The method of claim 12, further comprising storing speculative chromosomes and associated speculative counts in a speculative pool, a validation being initiated when a speculative chromosome in the speculative pool has a predetermined speculative count.

21. The method of claim 20, further comprising validating the entire speculative pool when at least one speculative chromosome has a predetermined speculative count.

22. A computer readable medium having computer executable instructions for performing a method comprising:
generating at least one generation of speculative chromosomes that represent value set variations of a plurality of value sets;
assigning a speculative count to speculative chromosomes based on a corresponding generation of the speculative chromosome; and
repeating the generating of speculative chromosome generations and assigning speculative counts, until at least one speculative chromosome has a predetermined speculative count.

23. The method of claim 22, further comprising approximating costs associated with speculative chromosomes in each speculative chromosome generation.

24. The method of claim 22, further comprising determining real costs associated with at least one speculative chromosome once at least one speculative chromosome has a predetermined speculative count.

25. The method of claim 22, further comprising storing a plurality of speculative chromosomes in a speculative pool, and determining real costs associated with the entire pool once at least one speculative chromosome in the speculative pool has a predetermined speculative count.

26. A system for minimizing a cost associated with a set of parameters representing a solution, the system comprising:
means for determining real costs associated with a plurality of real chromosomes;
means for generating generations of speculative chromosomes with assigned speculative counts corresponding to a generation number of the speculative chromosome, the speculative chromosome being assigned a speculative count that is higher than a parent chromosome from which it is derived; and
means for postponing validation of at least one speculative chromosome, until at least one speculative chromosome has a predetermined speculative count.

27. The system of claim 26, further comprising means for determining a speculative cost for a respective speculative chromosome.

28. The system of claim 26, further comprising means for validating, the means for validating executing a validation by executing the means for determining a real cost on at least one speculative chromosome.

29. The system of claim 28, the means for validating executing the means for determining a real cost on a plurality of speculative chromosomes retained in a speculative pool.
